(19) United States
(12) Patent Application Publication
(10) Pub. No.: US 2015/0153032 A1
(43) Pub. Date: Jun. 4, 2015

(54) LAMP

(71) Applicant: LEXTAR ELECTRONICS CORPORATION, HSINCHU (TW)

(72) Inventors: Yi-Tsung TSAI, New Taipei City (TW); Ho-Shun YANG, Hsinchu County (TW)

(21) Appl. No.: 14/324,021

(22) Filed: Jul. 3, 2014

(30) Foreign Application Priority Data
Nov. 29, 2013 (TW) 102143701

(51) Int. Cl. F21V 29/00; F21V 1/00; F21K 99/00

(52) U.S. Cl. CPC F21V 29/22; F21K 9/30; F21V 1/00

(57) ABSTRACT

A lamp comprises a heat-dissipation member, a light module, and a lampshade. The heat-dissipation member includes a heat sink and two first engaging mechanisms. The heat sink has a supporting surface. The first engaging mechanisms respectively project from the supporting surface and have an L-shaped extending portion and an engaging portion. The extending portion connects to the supporting surface, and the engaging portion connects to an end of the extending portion. The engaging portion and the supporting surface have an inclined angle. The light module is disposed on the supporting surface. The lampshade has two second engaging mechanisms respectively formed on two parallel sides thereof. The second engaging mechanisms respectively have a recess for receiving the engaging portion of the first engaging mechanism, wherein the second engaging mechanism cover the engaging portion and a part of the extending portion.

### CROSS REFERENCE TO RELATED APPLICATIONS

This application claims priority of Taiwan Patent Application No. 102143701, filed on Nov. 29, 2013, the entirety of which is incorporated by reference herein.

### BACKGROUND OF THE INVENTION

1. Field of the Invention

The present invention relates to a lamp, and in particular it relates to a lamp that prevents the lamp shade being separated therefrom.

2. Description of the Related Art

A lamp generally comprises a lamp shade and a heat-dissipation member, which can be engaged to each other. However, the lamp shade may be separated from the heat dissipation member when a pulling or a pressing force is applied thereto. Therefore, means of preventing the lamp shade from being separated from the heat-dissipation member by an external force while being simple to assemble the lamp become important issues.

### BRIEF SUMMARY OF THE INVENTION

The present invention provides a lamp, comprising a heat-dissipation member and a lamp shade. The heat-dissipation member comprises a heat sink, two first engaging mechanisms, and a light module. The heat sink has a support surface and a curved surface, wherein the curved surface is under the support surface and connected to two sides of the support surface, and the curved surface and the support surface define a receiving space. The two first engaging mechanisms respectively project from the two sides of the supporting surface and have an L-shaped extending portion and an engaging portion. The extending portion connects to the supporting surface, and the engaging portion connects to an end of the extending portion, wherein the engaging portion and the supporting surface have an inclined angle therebetween. The light module is disposed on the support surface. The lamp shade has two second engaging mechanisms respectively formed on two parallel sides thereof. The second engaging mechanisms respectively have a recess for receiving the engaging portion of the first engaging mechanism, wherein the second engaging mechanism covers the engaging portion and a part of the extending portion.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is sectional view of a lamp according to an embodiment of the invention;

FIG. 2 is a schematic view of the first engaging mechanisms according to an embodiment of the invention;

FIG. 3 is a schematic view of the second engaging mechanisms according to an embodiment of the invention; and

FIG. 4 is a schematic view of the first and second engaging mechanisms engaged with each other according to an embodiment of the invention.

### DETAILED DESCRIPTION OF THE INVENTION

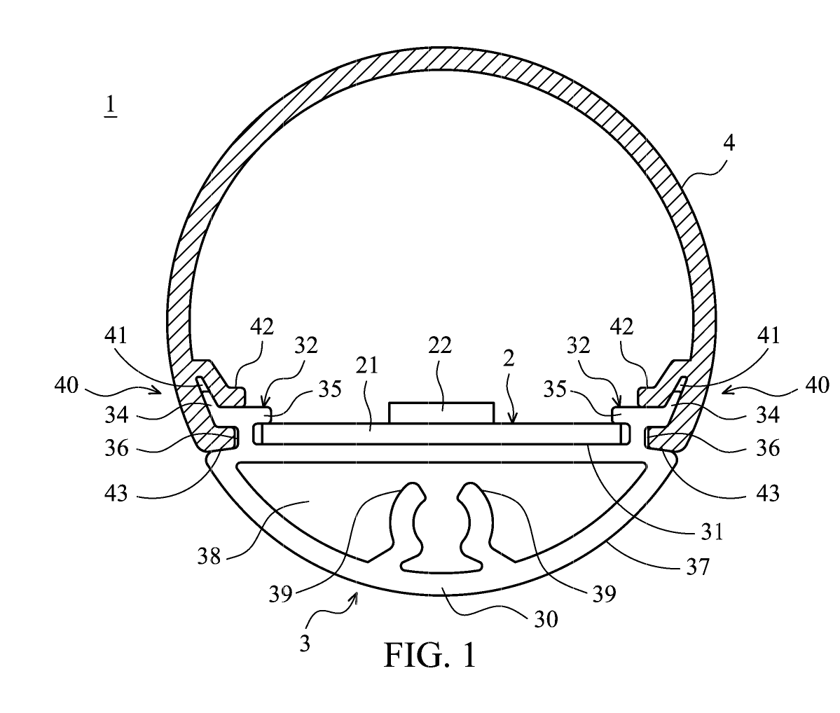

Referring to FIG. 1, an embodiment of a lamp 1 comprises a light module 2, a heat-dissipation member 3, and a curved lamp shade 4. The heat-dissipation member 3 mainly comprises a heat sink 30 and two first engaging mechanisms 32, wherein the heat sink 30 has a support surface 31 with the light module 2 disposed thereon. In this embodiment, the light module 2 may comprise a circuit board 21 and a plurality of LEDs 22 disposed on the circuit board 21. A curved surface 37 is formed under the support surface 31 and connected to two sides of the support surface 31, wherein the curved surface 37 and the support surface 31 define a receiving space 38 for receiving the driving device of the lamp or other components. Two sheets 39 are disposed in the receiving space 38 as a fixing means forming symmetrical curved structures, wherein the caps at both ends of the lamp can be fixed thereto by screws or other fasteners. The two second engaging mechanisms 40 are respectively formed on two parallel sides of the curved lamp shade 4, wherein the lamp 1 is assembled through the engagement between the first and second engaging mechanisms 32 and 40.

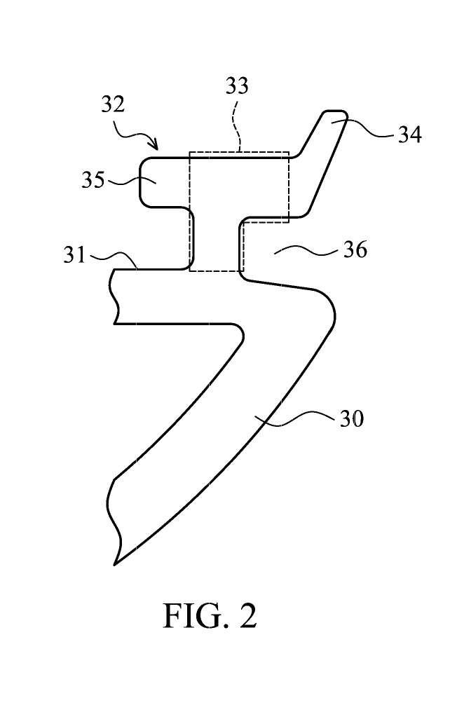

Referring to FIG. 1 and FIG. 2, in this embodiment, the two first engaging mechanisms 32 are respectively disposed on opposite sides of the heat sink 30 and project from the support surface 31. As shown in FIG. 2, the first engaging mechanism 32 comprises an L-shaped extending portion 33 and an engaging portion 34. The extending portion 33 is connected to the support surface 31 through an end thereof, and connected to the engaging portion 34 through another end thereof. A slot 36 is formed between the extending portion 33 and the heat sink 30. The engaging portion 34 projects upward from the extending portion 33, wherein the engaging portion 34 and the extending portion 33 have an inclined angle therebetween. In this embodiment, each of the first engaging mechanisms 32 further comprises a restricting portion 35 projecting inward from the extending portion 33 and forming a T-shaped structure with the first engaging mechanism 32, so that the light module 2 can be engaged between the restricting portions 35 and support surface 31. In some embodiments, the heat-dissipation member 3 may be integrally formed with the two first engaging mechanisms 32 by aluminum extrusion.

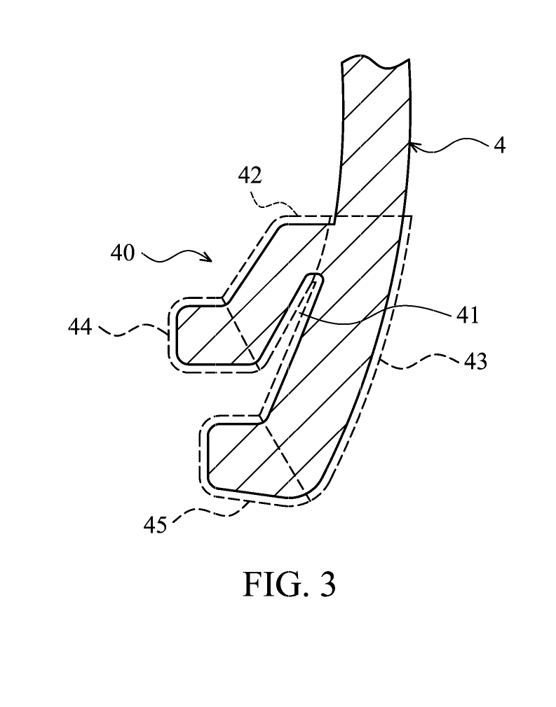

Referring to FIG. 1 and FIG. 3, the two second engaging mechanisms 40 are respectively formed on two parallel sides of the lamp shade 4, corresponding to the first engaging portion 32. The second engaging mechanism 40 is bifurcated from the end of the lamp shade 4 to form a first and second abutting portion 42 and 43 to contact the first engaging mechanism 32. As shown in FIG. 3, a first bending structure 44 is formed at the end of the first abutting portion 42 (as the dashed line indicates), and a second bending structure is formed on the end of the second abutting portion 43 (as the dashed line indicates), wherein a recess 41 is formed between the first and the second bending portions 44 and 45.

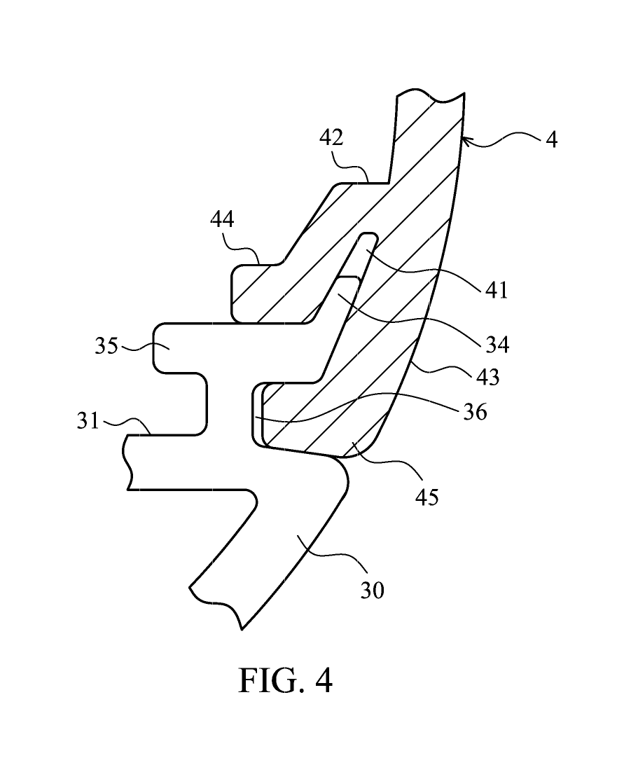

Referring to FIGS. 1 and 4, during assembly, the engaging portion 34 of the first engaging mechanism 32 is engaged into the recess 41, and the second abutting portion 43 of the second engaging mechanism 40 is engaged to the slot 36, wherein the second engaging mechanism 40 covers the engaging portion 34 and a part of the extending portion 33. Therefore, separation of the lamp shade 4 from the heat-dissipation member 3 can be prevented.

In detail, when the lamp shade 4 suffers an external force applied toward the heat-dissipation member 3, the first abutting portion 42 can contact the extending portion 33 and the engaging portion 34 to prevent separation of the lamp shade 4 from the heat-dissipation member 3. Additionally, when the lamp shade 4 suffers an external force applied toward a direction opposite to the heat-dissipation member 3, the second bending structure 45 can hook the extending portion 33 to prevent separation of the lamp shade 4 from the heat-dissipation member 3.

In conclusion, the lamp of the present invention has a structure preventing separation of the lamp shade and can be simply assembled. For example, during assembly of the lamp shade and the heat-dissipation member, the first and the second engaging mechanisms on one side of the lamp can be engaged at first, and then the first and the second engaging mechanisms on the other side of the lamp can also be engaged. Therefore, regardless of the length of the lamp, the lamp can be simply assembled.

The following description is of the best-contemplated mode of carrying out the invention. This description is made for the purpose of illustrating the general principles of the invention and should not be taken in a limiting sense. The scope of the invention is best determined by reference to the appended claims.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lamp, comprising:
a heat-dissipation member comprising:
a heat sink, having a support surface and a curved surface, wherein the curved surface is under the support surface and connected to two sides of the support surface, wherein the curved surface and the support surface define a receiving space;
two first engaging mechanisms, respectively projecting from the two sides of the supporting surface and having an L-shaped extending portion and an engaging portion, the extending portion connecting to the supporting surface, and the engaging portion connecting an end of the extending portion, wherein the engaging portion and the support surface have an inclined angle therebetween; and
a light module, disposed on the support surface; and
a lamp shade, having two second engaging mechanisms respectively formed on two edge parallel to each other, the second engaging mechanisms respectively having a recess for receiving the engaging portion of the first engaging mechanism, wherein the second engaging mechanism covers the engaging portion and a part of the extending portion.

2. The lamp as claimed in claim 1, wherein the first engaging mechanisms respectively comprise a restricting portion, and the restricting portion connects to the extending portion to form a T-shaped structure, wherein the light module is engaged between the restricting portion and the support surface.

3. The lamp as claimed in claim 2, wherein each of the second engaging mechanisms further comprises a first abutting portion, and the first abutting portion abuts the extending portion and the restricting portion.

4. The lamp as claimed in claim 3, wherein the extending portion and the heat sink form a slot therebetween, and each of the second engaging mechanisms further comprises a second abutting portion engaged with the slot.

5. The lamp as claimed in claim 4, wherein the recess is formed between the first and second abutting portions.

6. The lamp as claimed in claim 5, wherein the first and second abutting portions respectively has first and second bending structures, and the recess is formed between the first and the second bending structures.

7. The lamp as claimed in claim 1, wherein the heat sink further comprises a fixing device extended from the bottom of the curved surface and toward the supporting surface, and the fixing device is formed by two sheets spaced from each other.

8. The lamp as claimed in claim 1, wherein the heat-dissipation member is integrally formed with the two first engaging mechanisms by aluminum extrusion.

9. The lamp as claimed in claim 1, wherein the lamp shade has a curved structure.

10. The lamp as claimed in claim 1, wherein the light module includes a circuit board and a plurality of LEDs disposed on the circuit board.
